(19) United States
(12) Patent Application Publication
(10) Pub. No.: US 2025/0019011 A1
(43) Pub. Date: Jan. 16, 2025

(54) TAILGATE ASSEMBLY FOR THE CONTROLLED TRANSPORTATION OF MATERIAL IN A TRUCK

(71) Applicant: Sevenson Environmental Services, Inc., Niagara Falls, NY (US)

(72) Inventors: Fredrick Musgrove, Niagara Falls, NY (US); Stephen Kubida, Lockport, NY (US); James Pease, Newfane, NY (US); Wayne Kostuk, Niagara Falls, NY (US)

(21) Appl. No.: 18/220,602

(22) Filed: Jul. 11, 2023

(51) Int. Cl. B62D 33/027; B65F 3/02

(52) U.S. Cl. CPC B62D 33/0273; B65F 3/02; B65F 2003/0286

(57) ABSTRACT

A tailgate assembly for a truck bed for securely sealing material in the truck bed when the tailgate is in the closed position. The interior surface of the rear wall of the tailgate includes a channel with a resilient strip located so as to correspond to the perimetrical rear edge of the truck bed. When the tailgate assembly is in the closed position, the channel receives the perimetrical rear edge and compresses the resilient strip to seal the interior of the truck bed and prevent leakage of the materials in the truck bed.

### FIELD OF THE INVENTION

The present invention is an assembly for the controlled transportation of material in a truck. In particular, the present invention relates to a tailgate assembly for securely confining material in the body of a truck bed to prevent spillage.

### BACKGROUND OF INVENTION

The pollution caused by the unregulated discharge and dumping of industrial, agricultural and municipal wastes has severely damaged the environment. Federal and state laws have been enacted to limit the current discharge of pollutants and to remediate properties, as well as lakes, rivers and other bodies of water, that have been identified as particularly hazardous to the environment and the health of humans. The remediation can include some form of excavation or dredging to remove pollutants that have leached into the ground or settled to the bottom of bodies of water. The contaminated materials are often hazardous and are typically removed and transported to an approved disposal site for permanent interment. In order to safely transport the contaminated materials, the vehicles selected for transporting the materials must securely contain the materials until they arrive at the disposal site.

The trucks and other vehicles that are currently being used do not adequately contain the contaminated materials, which often results in the leakage and spillage of materials onto public roads and private property. The problem is exacerbated for vehicles such as dump trucks that have a tailgate assembly that opens to allow the discharge of the contaminated materials from the truck bed. When the tailgate assembly is closed prior to loading, it is difficult to form a secure seal between the tailgate assembly and the truck bed. Even a small crack or opening can allow contaminated materials to leak out of the truck bed, especially when the materials are watery or consist of small particle size dry materials. Accordingly, there is a need for a tailgate assembly that forms a tight seal with a truck bed and prevents the leakage of the materials being transported.

### SUMMARY OF THE INVENTION

In accordance with the present invention, a tailgate assembly is provided for securely sealing material in a truck bed when closed. The truck bed has a front end, a rear end, and an interior defined by a floor, a front wall, first and second opposing side walls, each having an interior side, an exterior side, a top, a midpoint, and a bottom. The truck bed has an open rear end, and a perimetrical rear edge extending along a rear end of each of the two opposing side walls and a rear end of the floor. The perimetrical rear edge of the truck bed can include a continuous raised portion that contacts the resilient strip. Preferably, the continuous raised portion includes a metal member welded to the perimetrical rear edge of the truck bed. The metal member elongated and can have any cross-sectional shape, preferably round, oval, triangular, square, pentahedral, hexahedral, heptahedral, or octahedral.

The tailgate assembly includes a substantially flat rear wall, first and second members, and a resilient strip. The substantially flat rear wall has an interior surface facing the interior of the truck bed, an opposing exterior surface, first and second side edges, top and bottom edges, and a perimetrical border extending continuously along the first side edge, the bottom edge, and the second side edge on the interior surface. The rear wall moves between an open position, wherein the material is discharged through the open rear end, and a closed position, wherein the perimetrical border of the rear wall contacts the perimetrical rear edge of the truck bed.

The first and second members pivotably move the rear wall between the open position and the closed position. Each of the first and second members has first and second ends and an intermediate point, wherein the first end of each member is attached to the first and second side edges, respectively, of the rear wall of the tailgate assembly. The intermediate point of each member is pivotably attached to the exterior of the opposing side walls, respectively, of the truck bed. Each intermediate point is preferably attached at a point between the top and midpoint of each side wall. In a preferred embodiment, the second end of each of the first and second members is connected to the bottom of each of the opposing side walls of the truck bed, respectively, by a piston actuator. Preferably, a bracket extends outwardly from the bottom of the exterior surface of each of the opposing side walls of the truck bed and one end of each of the piston actuators is attached to the respective brackets. The piston actuators pivotably move the rear wall of the tailgate assembly between the open position and the closed position.

The resilient strip is secured to and extends continuously along the perimetrical border of the interior surface of the rear wall and corresponds to the perimetrical rear edge of the truck bed so that the resilient strip snugly engages the perimetrical rear edge of the truck bed and seals the interior of the truck bed when the rear wall is in the closed position. The tailgate assembly can also include a channel formed in or on the interior surface of the rear wall, wherein the resilient strip is disposed in and secured to the channel. When the channel is formed on the interior surface, the channel can include a base wall and two opposing side walls extending upwardly from the base wall. The base wall is secured to the perimetrical border on the interior surface of the rear wall and the resilient strip is disposed in the channel between the two opposing side walls. Preferably, the base wall of the channel is secured to the interior surface of the rear wall by welding, with screws, with bolts and/or nuts, or using an adhesive.

In a preferred embodiment, the truck bed is mounted on a truck chassis having first and second sides that correspond to the first and second opposing sides of the truck bed. One or more hydraulic actuators move the front end of the truck bed between a level position and an elevated position. In this embodiment, the second end of each of the members is attached to the first and second sides, respectively, of the truck chassis by first and second adjustable cables. When the front end of the truck bed is in the elevated position, the rear wall of the tailgate assembly is in the open position.

### BRIEF DESCRIPTION OF THE FIGURES

The preferred embodiments of the tailgate assembly for securely sealing materials inside a truck bed, as well as other objects, features and advantages of this invention, will be apparent from the accompanying drawings wherein:

FIG. 1 is a peripheral view of the left side and rear of a truck with an embodiment of the tailgate assembly mounted on the truck bed.

FIG. 2 is a peripheral view of the right side and rear of the truck shown in FIG. 1.

FIG. 3 is a peripheral view of the front and left side of the tailgate assembly mounted on a truck bed.

FIG. 4 is a peripheral view of the rear and right side of the tailgate assembly mounted on the truck bed shown in FIG. 3.

FIG. 5 is a view of a first embodiment of the interior surface of the rear wall of the tailgate assembly, wherein the channel is attached to the surface of the rear wall.

FIG. 6 is a view of a second embodiment of the interior surface of the rear wall of the tailgate assembly, wherein the channel is formed below the surface of the rear wall.

FIG. 7 is a top view of the channel containing the resilient strip that is located on the interior surface of the rear wall shown in FIG. 5.

FIG. 8 is a view of the rear edge of the right side wall of the truck bed shown in FIG. 1.

FIG. 9 is a view of the rear edge of the right side wall of the truck bed shown in FIG. 8 after a metal member is welded to the rear edge.

FIG. 10 is a sectional view of an embodiment of the channel with a resilient strip prior to engaging the perimetrical rear edge of a truck bed.

FIG. 11 is a sectional view of the embodiment shown in FIG. 10 after the channel with a resilient strip engages the perimetrical rear edge of the truck bed.

FIG. 12 is a sectional view of another embodiment of the channel with a resilient strip prior to engaging the perimetrical rear edge of a truck bed with a metal member welded to the perimetrical rear edge.

FIG. 13 is a sectional view of the embodiment shown in FIG. 12 after the channel with a resilient strip engages the perimetrical rear edge of a truck bed with a metal member welded to the perimetrical rear edge.

### DETAILED DESCRIPTION OF THE INVENTION

The present invention is a tailgate assembly for securely sealing materials inside a truck bed when the tailgate is in a closed position. Trucks, such as dump trucks, currently being used for transporting a variety of materials, including soil, rocks, sand, vegetation, construction debris, and materials containing a high concentration of liquids, have an opening with a door (or wall) for discharging the materials. When the door or wall is in the closed position, the door often leaks and the materials leak out or are spilled. U.S. Pat. No. 4,323,279 to Domes et al., which is incorporated herein in its entirety, discloses a typical dump truck that is currently in use. In order to prevent spillage, it is necessary to provide a door that securely seals the interior of the truck bed and prevents leaks, while still capable of easy opening and closing.

In many industries, there is a need to haul excavated materials that are dry, damp, or wet in watertight trucks without leakage of material, whether hazardous or non-hazardous, from the trucks over public roadways or other areas that the trucks travel over. The present invention is a sealed tailgate system that ensures that the material will not leak from the tailgate. The tailgate assembly includes a rear wall that spans the entire width of the open back end of the truck bed between the opposing side walls when the tailgate assembly is in the closed position. A continuous, strip of resilient seal material is attached to the interior of the rear wall corresponding to the area of the rear wall that contacts the perimetrical rear edge of the truck bed. Preferably, the resilient strip is formed in a channel that extends along three side edges of the rear wall of the tailgate assembly. The channel wall closest to the left side, right side, and bottom edges of the rear wall can be aligned with the edges of the rear wall or it can be up to 6 inches from the edge of the rear wall based on where the perimetrical rear edge of the truck bed contacts the rear wall of the tailgate. When the tailgate assembly is in the closed position, the resilient strip compresses against the perimetrical rear edge of the truck bed to prevent the material inside from leaking out.

As used herein, the term “truck bed” refers to a structure mounted on a truck and used for receiving materials. The truck bed has a floor, three walls located on the opposing sides and on the front end, and an open rear end. The truck bed can have an open top that can be covered by a removable roof for containing the materials inside the truck bed during transport. The materials are typically loaded into the truck bed through the open top.

As used herein, the term “dump truck” refers to a vehicle having a chassis supporting a truck bed with a tailgate assembly that moves between a closed position, wherein the tailgate engages the open rear end of the truck bed to prevent the discharge of materials from the truck bed, and an open position, wherein the tailgate assembly pivotably moves away from the truck bed to permit the discharge of materials from the truck bed. The dump truck can also have a means, preferably one or more hydraulic actuators, for raising the front end of the truck bed to facilitate the discharge of materials from the truck bed through the rear end, when the tailgate is in the open position.

As used herein, the term “tailgate assembly” refers to system mounted on a truck bed for closing the open rear end of the truck bed. The tailgate assembly includes a rear wall, two pivoting members and one or more pistons for rotating the rear wall between an open position and a closed position that closes off or seals the open rear end of the truck bed.

As used herein, the term “perimetrical border” refers to the area on the interior surface of the rear wall of the tailgate assembly that contacts the perimetrical rear edge of the truck bed, i.e. the rear edges of the two side walls and the floor of the truck bed, when the tailgate assembly is in the closed position.

As used herein, the term “resilient strip” refers to a continuous length of compressible, impermeable material, preferably made from rubber or an elastic plastic. The resilient strip is used to form a watertight seal.

As used herein, the term “channel” refers to a structure on, or recessed in, the interior surface of the rear wall of the tailgate assembly that forms a space enclosed on three sides and open on the fourth side facing away from the interior surface of the rear wall. The channel is located so that it receives the rear edges of the two side walls and the rear edge of the truck bed when the tailgate assembly is in the closed position. The location of the channel in relation to the edges of the rear wall depends on the design of the truck bed and the rear wall of the tailgate assembly. Typically, the wall of the channel extends close to or along the edges of the side walls and the bottom of the rear wall.

The tailgate assembly pivotably travels in an arc between the open position and the closed position. As the tailgate assembly nears the closed position, the arc is designed to pull the gate inwardly so that it snugly engages the perimetrical rear edge of the open back end of the truck bed. The piston actuator stroke length is matched to limit the travel of the tailgate assembly to a position wherein the rear wall securely seals the rear end of the truck bed and the stops on the interior surface of the rear wall contact the floor of the truck bed. This creates a positive limit for the travel of the tailgate assembly. When the tailgate assembly is in the open position and the truck bed is raised, the materials discharged do not come into contact with the seal on the rear wall. This prevents any broken concrete, rocks and stones, sticks, bricks, metal, and/or any other debris from causing damage to the seal and reducing its effectiveness.

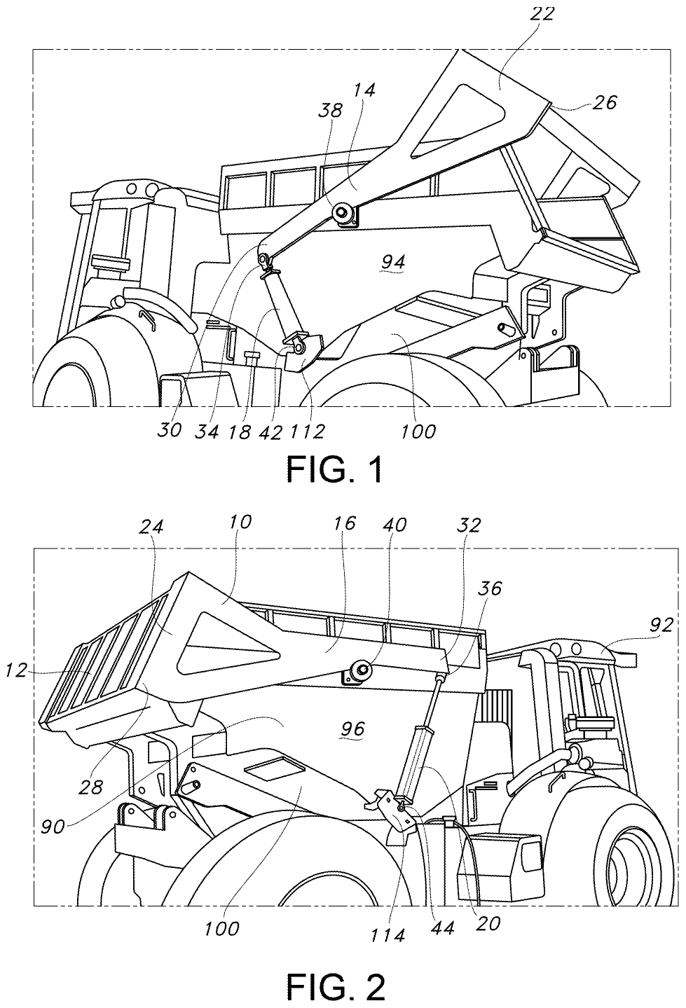

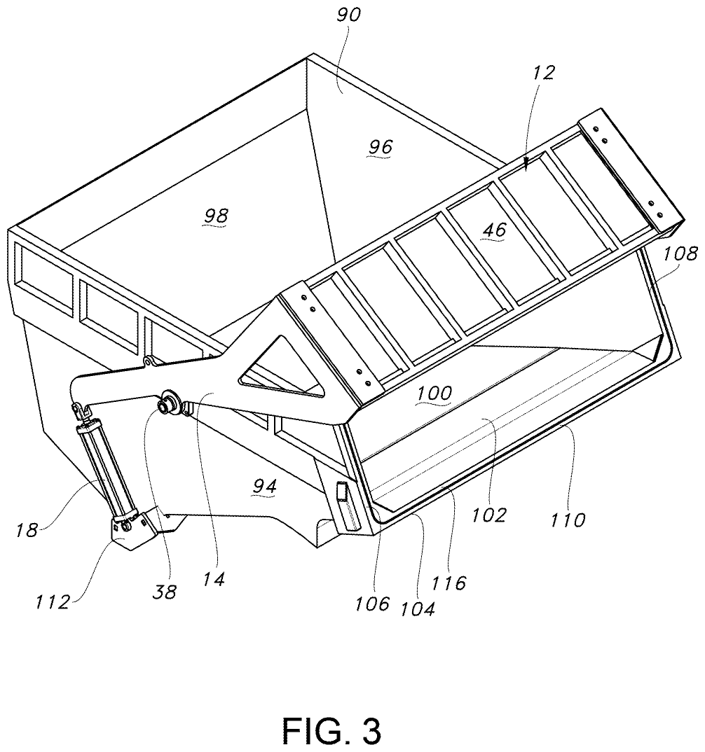

The tailgate assembly 10 will now be described with respect to FIGS. 1-13, which show specific embodiments of the tailgate assembly 10. FIGS. 1 and 2 show the tailgate assembly 10 mounted on a truck bed 90 of a dump truck 92. The tailgate assembly 10 includes a rear wall 12, a pair of pivoting members 14, 16, and a pair of piston actuators 18, 20 that move the rear wall 12 between an open position (FIG. 1) and a closed position (FIG. 2). The pivoting members 14, 16 each has a first end 22, 24 attached to the first and second opposing side edges 26, 28 of the rear wall 12 and a second end 30, 32 attached to the first ends 34, 36 of the piston actuators 18, 20. Each pivoting member 14, 16 also has a pivot point 38, 40 located between the first end 22, 24 and second end 30, 32, respectively, that is pivotably attached to the exterior of the opposing left and right side walls 94, 96, respectively, of the truck bed 90. The second ends 42, 44 of the piston actuators 18, 20 are connected between the midpoint and the bottom of the opposing side walls 94, 96, near the floor 98 of the truck bed 90. In the preferred embodiment shown in FIGS. 1 and 2, the tailgate assembly 10 is in the open position when the piston actuators 18, 20 are in the retracted position (see FIG. 1) and the piston rods are inside the piston housings. The tailgate assembly 10 is in the closed position when the piston actuators 18, 20 are in an extended position (see FIG. 2) and the piston rod is visible. When the tailgate assembly 10 is in the open position, the rear wall 12 is raised above the truck bed 90, which allows the material to be discharged from the truck bed 90.

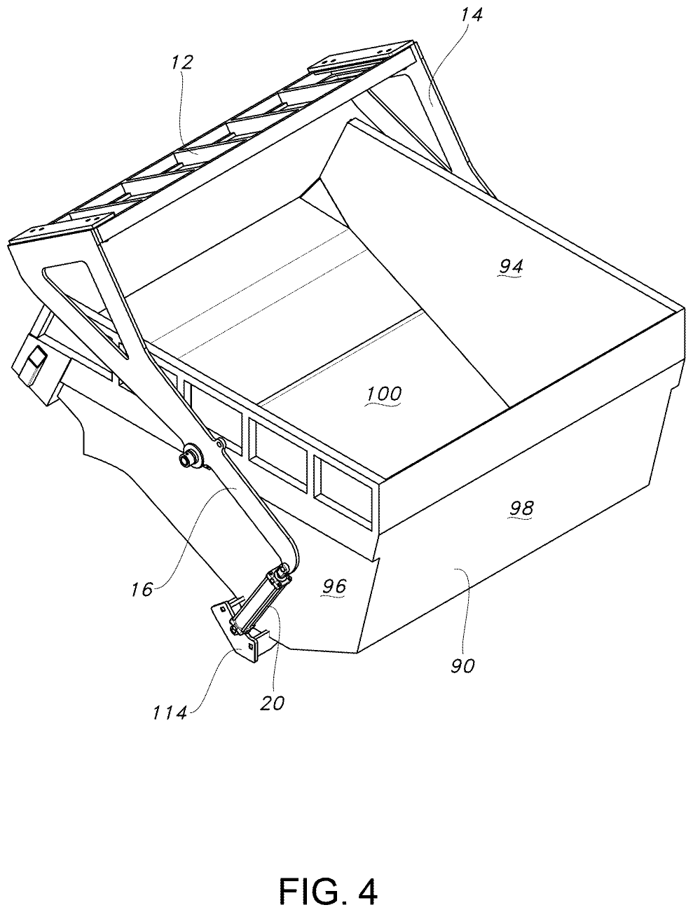

FIG. 3 shows a rear view and FIG. 4 shows a front view of the truck bed 90. The truck bed 90 includes the opposing left and right side walls 94, 96, respectively, a front wall 98, a floor 100, and an open rear end 102 with a perimetrical rear edge 104 extending along the rear edges 106, 108 of the left and right side walls 94, 96 and the rear edge 110 of the floor 100. The tailgate assembly 10 includes a rear wall 12 having an exterior surface 46 that is pivotably attached to the exterior of the side walls 94, 96. The piston actuators 18, 20 move the rear wall 12 between an open position and a closed position, wherein the rear wall 12 encloses the open rear end 102 of the truck bed 90. One end of each piston actuator 18, 20 is preferably attached to a bracket 112, 114 welded on the exterior, near the bottom of the opposing left and right side walls 94, 96. In a preferred embodiment, a steel member 116 is attached (preferably welded) to the middle of the perimetrical rear edge 104 of the truck bed 90 (see FIG. 3).

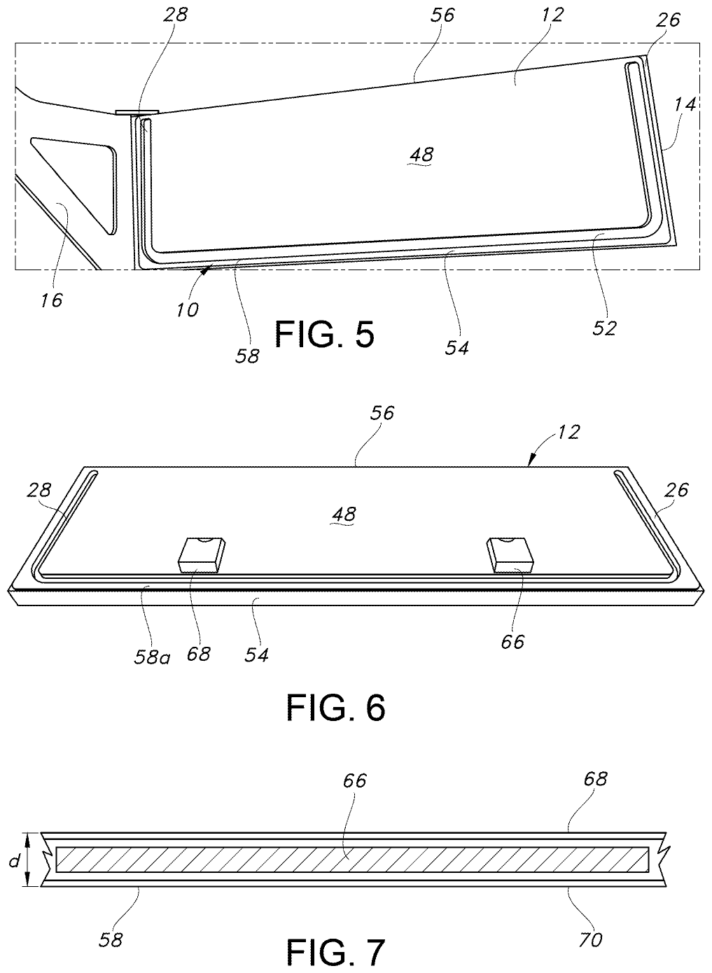

FIG. 5 shows an embodiment of the rear wall 12 that includes an interior surface 48 that faces the interior 50 of the truck bed 90. The pair of pivoting members 14, 16 are attached to the first and second side edges 26, 28 of the rear wall 12. A perimetrical border 52 extends continuously along the first side edge 26, the bottom edge 54, the second side edge 28 on the interior surface 48, and optionally along the top edge 56 of the interior surface 48 of the rear wall 12. A channel 58 is formed on the perimetrical border 52, preferably along the two side edges 26, 28 and the bottom edge 54. The channel 58 can be formed by a metal channel having a elongated, substantially flat base 60 with two opposing side walls 62, 64 extending upwardly from the opposing sides of the base 60 and welded to the interior surface 48. The channel 58 can also be formed by welding parallel metal walls 62, 64 to the interior surface 48 of the rear wall 12.

FIG. 6 shows a second embodiment of the rear wall 12 with a channel 58a recessed in the interior surface 48 of the rear wall 12. The channel 58a is integrally formed as part of the rear wall 12. FIG. 6 also shows a pair of stops 66, 68 positioned on the interior surface 48 along the bottom edge 54 so that the channel 58 is disposed between the stops 66, 68 and the bottom edge 54. The stops 66, 68 aid in aligning the rear wall 12 of the tailgate assembly 10 to the truck bed 90 and act as a failsafe if the piston actuators 18, 20 malfunction, preventing the rear wall 12 from continuing to move in a downward direction. The tailgate assembly's 10 downward arc is stopped by the internal tailgate stops 66, 68 when the maximum stroke limit of the piston actuators 18, 20 is reached.

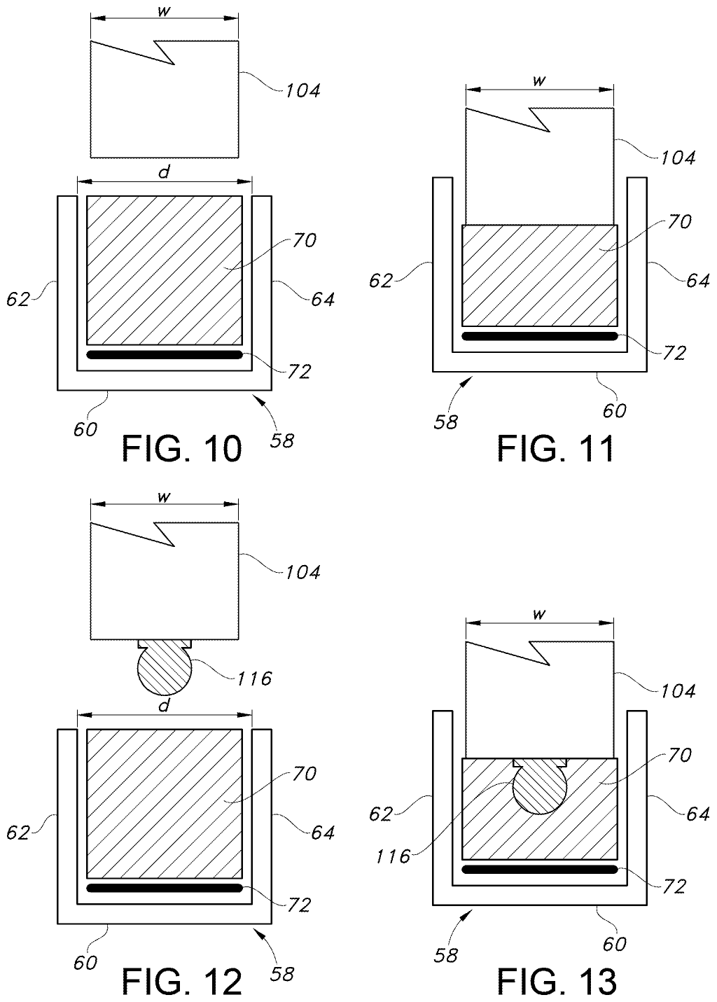

FIG. 7 shows a top view of the channel 58 with a resilient strip 70 disposed within the channel 58 and attached using an adhesive 72 (see FIGS. 10-13). The channel 58 is sized so that the distance “d” between the opposing side walls 62, 64 is greater than the width “w” of the perimetrical rear edge 104 of the truck bed 12. This allows the perimetrical rear edge 104 to easily pass between the side walls 62, 64 and engage the resilient strip 70. (See FIGS. 10-13.)

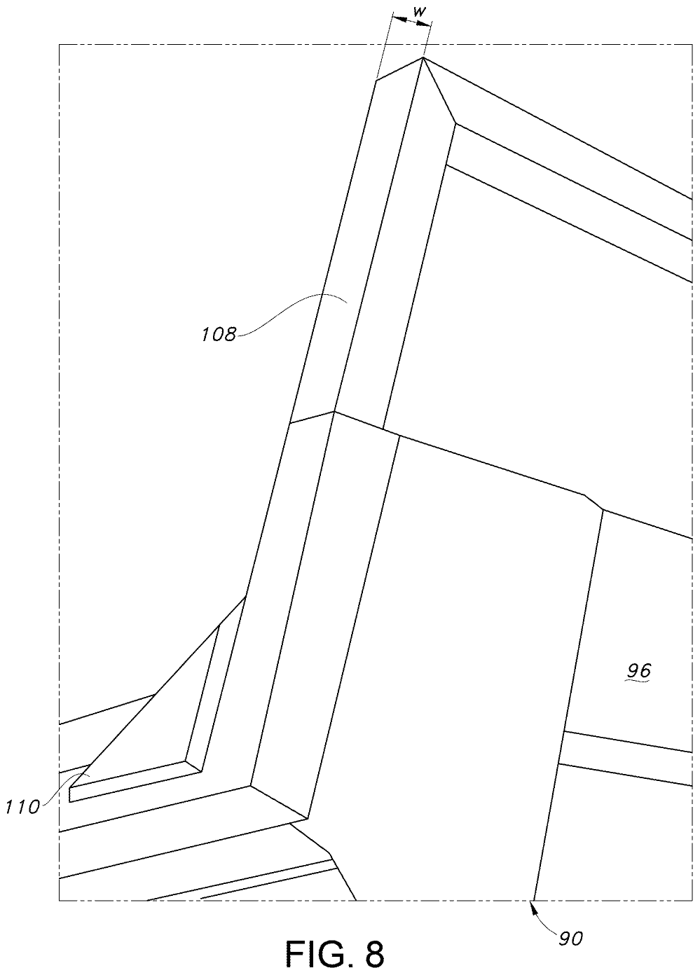

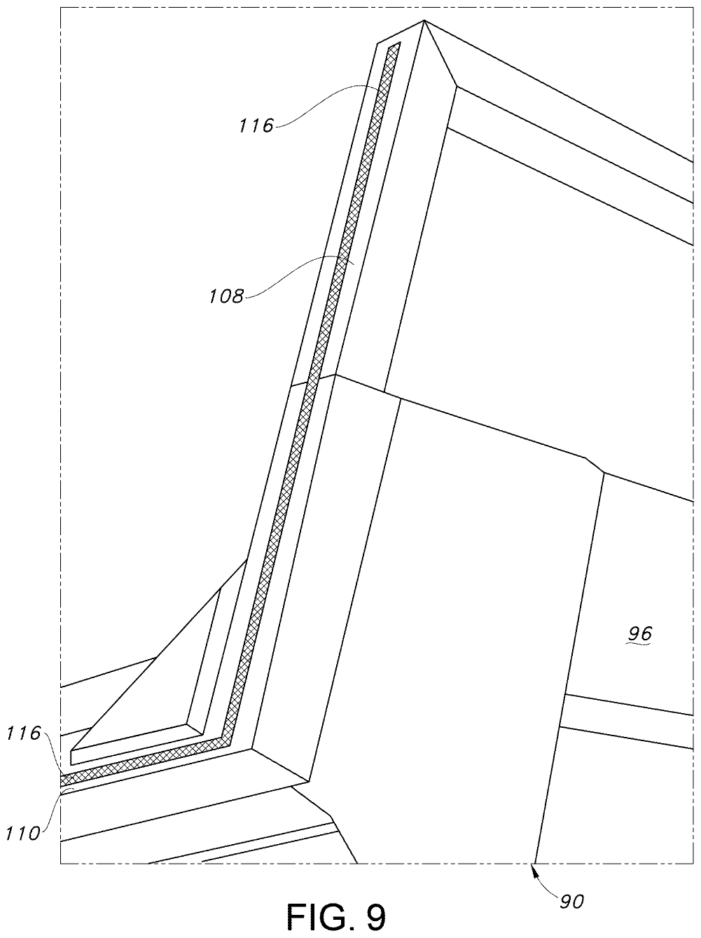

FIG. 8 shows the right rear edge 108 of the right side wall 96 of the truck bed 90. FIG. 9 shows a metal member 116 welded onto the same right rear edge 108. Another metal member 116 is welded onto the rear edge 110 of the floor 100 of the truck bed 90, as well as the left rear edge 106 of the left side wall 94 of the truck bed 90. The metal members 116 extend continuously along the perimetrical rear edge 104 of the truck body 90 on three sides as shown in FIG. 4.

FIGS. 10-13 show side cross-sectional views of the channel 58 on the rear wall 12 of the tailgate assembly 10 before and after engaging the perimetrical rear edge 104 of the truck bed 90. FIGS. 10 and 12 show a resilient strip 70 secured in the channel 58 by an adhesive 72 when the tailgate assembly 10 is in the open position. FIGS. 11 and 13 show the resilient strip 70 when the tailgate assembly 10 is in the closed position. FIGS. 10 and 11 show the perimetrical rear edge 104 of the truck bed 90 without a metal member before and after the perimetrical rear edge 104, respectively, compressively engages the resilient strip 70 in the channel 58. FIGS. 12 and 13 show the perimetrical rear edge 104 of the truck bed 90 with a metal member 116 before and after the perimetrical rear edge 104, respectively, compressively engages the resilient strip 70 in the channel 58. The channel 58 is designed so that it is wide enough for the perimetrical rear edge 104 of the truck bed 90 to pass between the side walls 62, 64 of the channel 58. The resilient strip 70 in the channel 58 snugly engages the perimetrical rear edge 104 and forms a tight seal so that materials cannot leak out of the truck bed 90. The metal strip 116 shown in FIGS. 12 and 13 passes further into the resilient strip 66 than the perimetrical rear edge 104 and provides a preferred means for sealing the materials in the truck bed 90.

### EXAMPLE

Three lengths of elongated channel steel having a bottom wall with two side walls extending upwardly from the opposing sides were cut to the approximate lengths of the rear edge of the two side walls and the floor of a truck bed. The channel steel was fabricated to form a continuous U-shaped channel that fit over the rear perimetrical edge of the truck bed and was welded onto the interior surface of the rear wall of the tailgate assembly. A 1-in. inside diameter heater hose was cut open along its length and flattened so that the outer protective surface was on the bottom and the soft rubber inner surface was on top. The outer protective surface of the hose was sanded to create a bonding surface and holes were drilled into the flat, sanded hose. A urethane sealant was used to coat the inside walls of the channel and the outer protective surface of the hose was pressed into the channel against the bottom wall and between the side walls and against the urethane sealant. When the hose was pressed into the channel, the holes allowed the sealant to infiltrate the outer protective surface to aid adhesion of the hose to the channel. The tailgate assembly with the channel on the interior side was mounted on the truck bed. When the tailgate assembly was moved into the closed position, the rear perimetrical edge of the truck bed was received by the U-shaped channel and pressed against the hose to create a seal that prevented leakage of material from the truck bed.

We claim:

1. A tailgate assembly for securely sealing material in a truck bed when closed, the truck bed having a front end, a rear end, and an interior defined by a floor, a front wall, first and second opposing side walls, each having an interior side, an exterior side, a top, a midpoint, and a bottom, wherein the truck bed has an open rear end, and a perimetrical rear edge extending along a rear end of each of the two opposing side walls and a rear end of the floor, wherein the tailgate assembly comprises:
a substantially flat rear wall having an interior surface facing the interior of the truck bed, an opposing exterior surface, first and second side edges, top and bottom edges, and a perimetrical border extending continuously along the first side edge, the bottom edge, and the second side edge on the interior surface, wherein the rear wall moves between an open position, wherein the material is discharged through the open rear end, and a closed position, wherein the perimetrical border of the rear wall contacts the perimetrical rear edge of the truck bed;
first and second members that pivotably move the rear wall between the open position and the closed position; and
a resilient strip secured to and extending continuously along the perimetrical border of the interior surface of the rear wall and corresponding to the perimetrical rear edge of the truck bed so that the resilient strip snugly engages the perimetrical rear edge of the truck bed and seals the interior of the truck bed when the rear wall is in the closed position.

2. The tailgate assembly according to claim 1, wherein the perimetrical rear edge of the truck bed comprises a continuous raised portion that contacts the resilient strip.

3. The tailgate assembly according to claim 2, wherein the continuous raised portion comprises a continuous, elongated metal member welded to the perimetrical rear edge of the truck bed.

4. The tailgate assembly according to claim, 1 further comprising a channel formed in or on the interior surface of the rear wall, wherein the resilient strip is disposed in and secured to the channel.

5. The tailgate assembly according to claim 4, wherein the channel comprises a base wall and two opposing side walls extending upwardly from the base wall, wherein the base wall is secured to the perimetrical border on the interior surface of the rear wall and the resilient strip is disposed in the channel between the two opposing side walls.

6. The tailgate assembly according to claim 5, wherein the base wall of the channel is secured to the interior surface of the rear wall by welding, with screws, with bolts and/or nuts, or using an adhesive.

7. The tailgate assembly according to claim 1, wherein the first and second members each having first and second ends and an intermediate point, wherein the first end of each member is attached to the first and second side edges, respectively, of the rear wall of the tailgate assembly and the intermediate point of each member is pivotably attached to the exterior of the opposing side walls, respectively, of the truck bed.

8. The tailgate assembly according to claim 7, wherein the second end of each of the first and second members is connected to the bottom of each of the opposing side walls of the truck bed, respectively, by a piston actuator, and wherein the piston actuators pivotably move the rear wall of the tailgate assembly between the open position and the closed position.

9. The tailgate assembly according to claim 8, wherein a bracket extends outwardly from the bottom on the exterior surface of each of the opposing side walls of the truck bed and one end of each of the piston actuators is attached to the respective brackets.

10. The tailgate assembly according to claim 1, wherein the truck bed is mounted on a truck chassis having first and second sides that correspond to the first and second opposing sides of the truck bed, wherein one or more hydraulic actuators move the front end of the truck bed between a level position and an elevated position, and wherein the second end of each of the members is attached to the first and second sides, respectively, of the truck chassis by first and second adjustable cables so that, when the front end of the truck bed is in the elevated position, the rear wall of the tailgate assembly is in the open position.

11. A tailgate assembly for securely sealing material in a truck bed when closed, the truck bed having a front end, a rear end, and an interior defined by a floor, a front wall, first and second opposing side walls, each having an interior side, an exterior side, a top, a midpoint, and a bottom, wherein the truck bed has an open rear end, and a perimetrical rear edge extending along a rear end of each of the two opposing side walls and a rear end of the floor, wherein the tailgate assembly comprises:
a substantially flat rear wall having an interior surface facing the interior of the truck bed, a channel formed in or on the interior surface, an exterior surface, first and second side edges, top and bottom edges, and a perimetrical border extending continuously along the first side edge, the bottom edge, and the second side edge on the interior surface and corresponding to the perimetrical rear edge of the truck bed, wherein the channel is located in the perimetrical border, wherein the rear wall moves between an open position, wherein the material is discharged through the open rear end, and a closed position, wherein the perimetrical border of the rear wall contacts the perimetrical rear edge of the truck bed;
first and second members that pivotably move the rear wall between the open position and the closed position;
first and second piston actuators for operably moving the first and second members; and
a resilient strip disposed in and secured to the channel so that the resilient strip snugly engages the perimetrical rear edge of the truck bed and seals the interior of the truck bed when the rear wall is in the closed position.

12. The tailgate assembly according to claim 11, wherein a continuous elongated metal member is welded to the perimetrical rear edge of the truck bed and contacts the resilient strip when the tailgate assembly is in the closed position.

13. The tailgate assembly according to claim 11, wherein the channel comprises a base wall and two opposing side walls extending upwardly from the base wall, and wherein the base wall is fixedly secured to the interior surface of the rear wall by welding, with screws, with bolts and/or nuts, or using an adhesive.

14. The tailgate assembly according to claim 1, wherein the first and second members each having first and second ends and an intermediate point, wherein the first end of each member is attached to the first and second side edges, respectively, of the rear wall of the tailgate assembly and the intermediate point of each member is pivotably attached to the exterior of the opposing side walls, respectively, of the truck bed, and wherein the second end of each of the first and second members is connected to the bottom of each of the opposing side walls of the truck bed, respectively, by the piston actuators.

15. A tailgate assembly for securely sealing material in a truck bed when closed, the truck bed having a front end, a rear end, and an interior defined by a floor, a front wall, first and second opposing side walls, each having an interior side, an exterior side, a top, a midpoint, and a bottom, wherein the truck bed has an open rear end, and a perimetrical rear edge extending along a rear end of each of the two opposing side walls and a rear end of the floor, wherein the tailgate assembly comprises:
a substantially flat rear wall having an interior surface facing the interior of the truck bed, an opposing exterior surface, first and second side edges, top and bottom edges, and a perimetrical border extending continuously along the first side edge, the bottom edge, and the second side edge on the interior surface, wherein the rear wall moves between an open position, wherein the material is discharged through the open rear end, and a closed position, wherein the perimetrical border of the rear wall contacts the perimetrical rear edge of the truck bed;
first and second members that pivotably move the rear wall between the open position and the closed position;
a channel formed in or on the interior surface of the rear wall and extending continuously along the perimetrical border of the interior surface of the rear wall, wherein the channel is positioned so as to correspond to the perimetrical rear edge of the truck bed;
a resilient strip disposed in and secured to the channel; and
a continuous, elongated metal member affixed to the perimetrical rear edge of the truck bed, wherein the continuous, elongated metal member contacts and snugly engages the resilient strip when the rear wall is in the closed position and seals the interior of the truck bed.

16. The tailgate assembly according to claim 15, wherein the channel comprises a base wall and two opposing side walls extending upwardly from the base wall, wherein the base wall is secured to the perimetrical border on the interior surface of the rear wall and the resilient strip is disposed in the channel between the two opposing side walls.

17. The tailgate assembly according to claim 15, wherein the resilient material is a compressible, impermeable material.

18. The tailgate assembly according to claim 15, wherein the resilient material is rubber or an elastic plastic.

19. The tailgate assembly according to claim 15, wherein the continuous, elongated metal member has a round, oval, triangular, square, pentahedral, hexahedral, heptahedral, or octahedral cross-sectional shape.

20. The tailgate assembly according to claim 15, wherein the continuous, elongated metal member is welded to the perimetrical rear edge of the truck bed.
